(19) United States
(12) Patent Application Publication
(10) Pub. No.: US 2016/0012401 A1
(43) Pub. Date: Jan. 14, 2016

(54) Methods for Discovering and Purchasing Content for Marine Electronics Device

(71) Applicant: Navico Holding AS, Egersund (NO)

(72) Inventors: Shane Coloney, Jenks, OK (US); Gregory Konig, Tulsa, OK (US); Tom Isaacson, Auckland (NZ); Phillip King Gaynor, Pocasset, MA (US)

(21) Appl. No.: 14/512,184

(22) Filed: Oct. 10, 2014

Related U.S. Application Data
(60) Provisional application No. 62/040,767, filed on Aug. 22, 2014.
(60) Provisional application No. 62/022,064, filed on Jul. 8, 2014.

(51) Int. Cl. G06Q 20/12; H04W 4/00; G06Q 20/40; G06Q 30/06

(52) U.S. Cl. CPC G06Q 20/123; G06Q 30/0633; H04W 4/005; G06Q 20/40

(57) ABSTRACT

Various implementations described herein are directed to a marine electronics device. The marine electronics device may include one or more processors and a memory. The memory may have a plurality of executable instructions. When the executable instructions are executed by the one or more processors, the processors may send a request from the marine electronics device to a cloud server. The request may purchase content for the marine electronics device or one or more peripheral devices in communication with the marine electronics device. The processors may also receive the purchased content at the marine electronics device.

### CROSS-REFERENCE TO RELATED APPLICATIONS

This application claims the benefit of U.S. Provisional Patent Application Ser. No. 62/022,064, filed Jul. 8, 2014, titled VARIOUS SOFTWARE FEATURES FOR MARINE ELECTRONICS DEVICE, and the disclosure of which is incorporated herein by reference.

This application also claims the benefit of U.S. Provisional Patent Application Ser. No. 62/040,767, filed Aug. 22, 2014, titled VARIOUS SOFTWARE FEATURES FOR MARINE ELECTRONICS DEVICE, and the disclosure of which is incorporated herein by reference.

### BACKGROUND

This section is intended to provide background information to facilitate a better understanding of various technologies described herein. As the section's title implies, this is a discussion of related art. That such art is related in no way implies that it is prior art. The related art may or may not be prior art. It should therefore be understood that the statements in this section are to be read in this light, and not as admissions of prior art.

Various forms of marine electronics data may be processed and/or displayed using a computing device disposed aboard a vessel. In one scenario, the computing device may include a multi-function display (MFD). Marine electronics data displayed using the computing device may be used to help navigate the vessel, and the data may include, for example, sonar data, chart data, radar data, or navigation data such as laylines.

### SUMMARY

Described herein are implementations of various technologies for a marine electronics device. The marine electronics device may include one or more processors and a memory. The memory may have a plurality of executable instructions. When the executable instructions are executed by the one or more processors, the processors may send a request from the marine electronics device to a cloud server. The request may purchase content for the marine electronics device or one or more peripheral devices in communication with the marine electronics device. The processors may also receive the purchased content at the marine electronics device.

Described herein are implementations of various technologies for a method. In one implementation, a non-transitory computer-readable medium having stored thereon computer-executable instructions which, when executed by a computer, cause the computer to perform various actions. The actions may include receiving a request from a marine electronics device to purchase content. The request may correspond to financial information associated with a user. The actions may include determining whether to authorize a purchase transaction for the purchased content based on the financial information. If the purchase transaction is authorized, the actions may include providing a download location for the purchased content to the marine electronics device.

Described herein are implementations of various technologies for a method. In one implementation, a non-transitory computer-readable medium having stored thereon computer-executable instructions which, when executed by a computer, cause the computer to perform various actions. The actions may include receiving a request, at a marine electronics device, to display content that is available for download from a mobile content store. The mobile content store may be in communication with the marine electronics device. The actions may include displaying the content on the marine electronics device in response to the request.

The above referenced summary section is provided to introduce a selection of concepts in a simplified form that are further described below in the detailed description section. The summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

Implementations of various techniques will hereafter be described with reference to the accompanying drawings. It should be understood, however, that the accompanying drawings illustrate only the various implementations described herein and are not meant to limit the scope of various techniques described herein.

FIG. 1 illustrates a marine networking system in accordance with implementations of various techniques described herein.

FIG. 2 is a flow diagram of a method for accessing a mobile content store in accordance with implementations of various techniques described herein.

FIG. 3 is a flow diagram of a method for purchasing content in accordance with implementations of various techniques described herein.

FIG. 4 illustrates a schematic of a marine electronics device in accordance with implementations of various techniques described herein.

FIG. 5 illustrates a schematic diagram of a computing system in which the various technologies described herein may be incorporated and practiced.

### DETAILED DESCRIPTION

The discussion below is directed to certain specific implementations. It is to be understood that the discussion below is only for the purpose of enabling a person with ordinary skill in the art to make and use any subject matter defined now or later by the patent “claims” found in any issued patent herein.

It is specifically intended that the claimed invention not be limited to the implementations and illustrations contained herein, but include modified forms of those implementations including portions of the implementations and combinations of elements of different implementations as come within the scope of the following claims. It should be appreciated that in the development of any such actual implementation, as in any engineering or design project, numerous implementation-specific decisions must be made to achieve the developers' specific goals, such as compliance with system-related and business related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure. Nothing in this application is considered critical or essential to the claimed invention unless explicitly indicated as being “critical” or “essential.”

Reference will now be made in detail to various implementations, examples of which are illustrated in the accompanying drawings and figures. In the following detailed description, numerous specific details are set forth in order to provide a thorough understanding of the present disclosure. However, it will be apparent to one of ordinary skill in the art that the present disclosure may be practiced without these specific details. In other instances, well-known methods, procedures, components, circuits and networks have not been described in detail so as not to unnecessarily obscure aspects of the embodiments.

It will also be understood that, although the terms first, second, etc. may be used herein to describe various elements, these elements should not be limited by these terms. These terms are only used to distinguish one element from another. For example, a first object or step could be termed a second object or step, and, similarly, a second object or step could be termed a first object or step, without departing from the scope of the invention. The first object or step, and the second object or step, are both objects or steps, respectively, but they are not to be considered the same object or step.

The terminology used in the description of the present disclosure herein is for the purpose of describing particular implementations only and is not intended to be limiting of the present disclosure. As used in the description of the present disclosure and the appended claims, the singular forms “a,” “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises” and/or “comprising,” when used in this specification, specify the presence of stated features, integers, steps, operations, elements, and/or components, but do not preclude the presence or addition of one or more other features, integers, steps, operations, elements, components and/or groups thereof.

As used herein, the term “if” may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context. As used herein, the terms “up” and “down”; “upper” and “lower”; “upwardly” and downwardly”; “below” and “above”; and other similar terms indicating relative positions above or below a given point or element may be used in connection with some implementations of various technologies described herein.

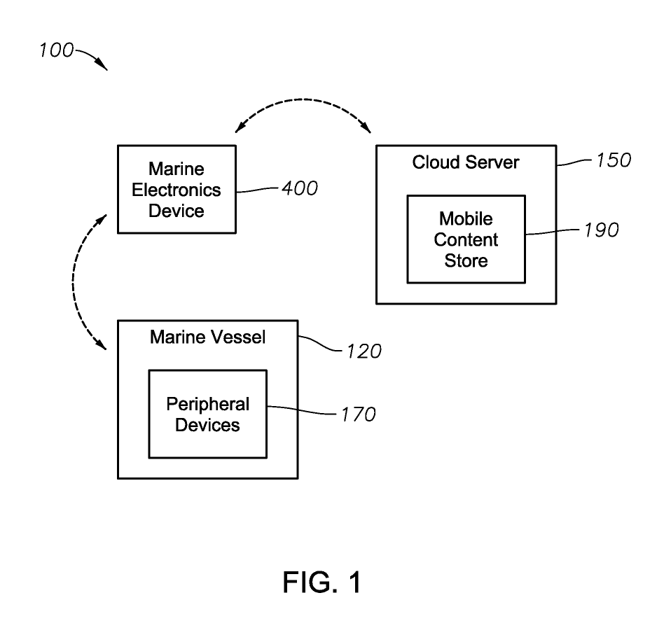

FIG. 1 illustrates a block diagram of a marine networking system 100 in accordance with implementations of various techniques described herein. The marine networking system 100 may include several components, such as a marine electronics device 400 (which may be a multi-function display or a chartplotter), a cloud server 150, a marine vessel 120 and peripheral devices 170 disposed on the marine vessel 120 that may be in communication with the marine electronics device 400. The cloud server 150 may be a server located on the Internet, which may be operated by a vendor. The marine electronics device 400 may manage and control the operation of various navigation related systems and the peripheral devices 170 disposed onboard the marine vessel 120. The peripheral devices 170 may include a sonar system, a Global Positioning System (GPS) device, such as a GPS receiver or a similar device such as GLONASS or global navigation satellite system (GNSS) receiver, a radar system, a propulsion system for the marine vessel 120, various navigation systems, and any other systems, such as lighting systems, wireless data communication devices, wireless audio communications devices, audio and video entertainment devices, weather and environmental sensor systems, etc., disposed on the marine vessel 120. The marine electronics device 400 may communicate with the peripheral devices 170 using a National Marine Electronics Association (NMEA) communication protocol or other mutually compatible protocol. For more information regarding the marine electronics device 400, see the section titled MARINE ELECTRONICS DEVICE below.

A mobile content store 190 may provide users with the ability to discover and purchase content for the marine electronics device 400 or the peripheral devices 170. The mobile content store 190 may be implemented using software and/or hardware located on the cloud server 150, but in some implementations may be implemented using software and/or hardware that is located on the marine electronics device 400 as well. Further, the mobile content store 190 may serve as an intermediary between users seeking to purchase content and vendors offering to sell their products for download. For instance, a web browser included in the user interface of the marine electronics device 400 may provide access to the mobile content store 190. An icon may be located on the user interface of the marine electronics device 400, which opens the mobile content store 190 into the web browser. As such, the mobile content store 190 may be part of an eCommerce platform. In some implementations, the marine electronics device 400 may use a “walled garden” setup that limits a user's access on the Internet only to the mobile content store 190 (i.e., the web browser may be prevented from browsing other sites on the Internet except the mobile content store 190).

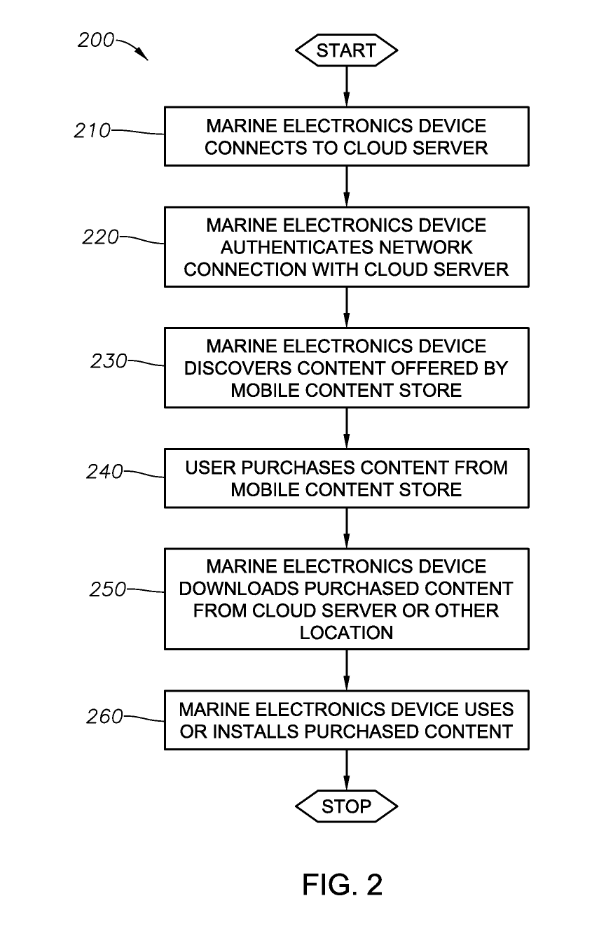

FIG. 2 illustrates a flow diagram for a method 200 of using the mobile content store 190 in accordance with implementations of various techniques described herein. In one implementation, method 200 may be performed by the marine electronics device 400. It should be understood that while method 200 indicates a particular order of execution of operations, in some implementations, certain portions of the operations might be executed in a different order. Further, in some implementations, additional operations or steps may be added to the method 200. Likewise, some operations or steps may be omitted.

At block 210, the marine electronics device 400 may connect to the cloud server 150. A network connection to the cloud server 150 may be a wired or wireless connection. For instance, the marine electronics device 400 may search for an available connection to the Internet from a nearby router, WiFi hotspot, cellular tower or another source of Internet access.

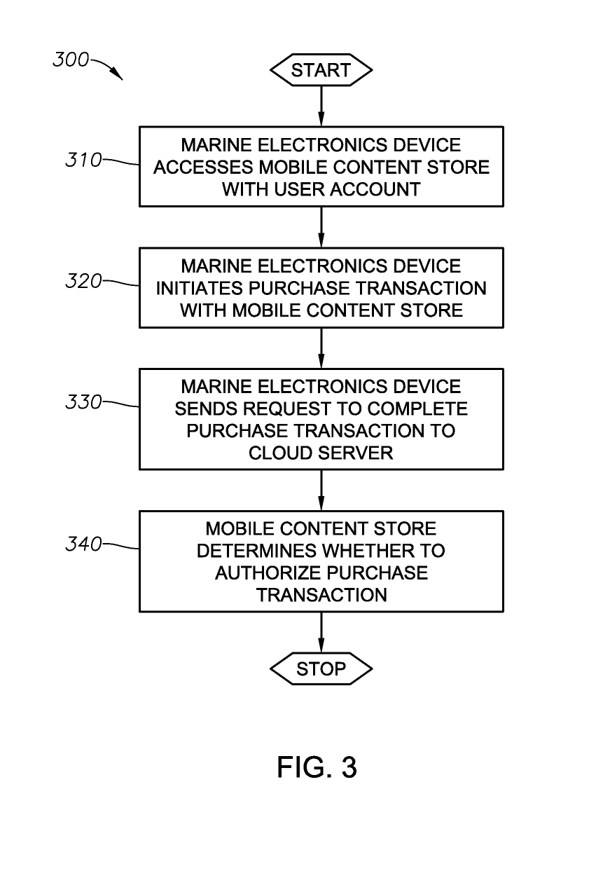

At block 220, the marine electronics device 400 may authenticate a network connection with the cloud server 150 (also referred to as a “handshake”). To authenticate the network connection, the marine electronics device 400 may send security information (e.g., password information) to the cloud server 150 to verify that the marine electronics device 400 is associated with a particular user or user account. As such, the security information may correspond to information stored in a designated user account on the cloud server 150. For more information regarding user accounts, see blocks 310-320 of FIG. 3 and the accompanying description below.

If the cloud server 150 verifies that the security information matches a designated user account, the cloud server 150 may create a secure connection with the marine electronics device 400. The secure connection may encrypt information that is sent between the cloud server 150 and the marine electronics device 400. Once a secure connection has been established, the cloud server 150 may provide the marine electronics device 400 with access to one or more features offered by the mobile content store 190 (e.g., discovering content at block 230 or purchasing content at block 240).

At block 230, the marine electronics device 400 may discover content offered by the mobile content store 190 (i.e., “the offered content”). The offered content may be configured for use with the marine electronics device 400 or the peripheral devices 170. The offered content may include content available for purchase from the mobile content store 190 as well as content available for free download from the mobile content store 190. For instance, the offered content may include navigation charts, maps, weather information, fishing information, software applications, musical content, entertainment media, games, and other similar data that may be displayed or used by the marine electronics device 400 or the peripheral devices 170. In one implementation, the offered content may be updated in real-time (e.g., the weather status of a region may be updated with new forecast information).

To determine what content is offered by the mobile content store 190, a web browser on the marine electronics device 400 may provide a menu that shows different products for different devices (e.g., sonar systems, radar systems, etc.) as well as recommendations for a particular user. In one implementation, offered content that was previously purchased by the particular user may be highlighted or removed from the menu.

To discover offered content, a user may search the mobile content store 190 based on the type of content (e.g., software applications for use with the marine electronics device 400 or the peripheral devices 170) or any other search criteria. For instance, the user may input a request to display information regarding available content that is offered for a particular device, e.g., the marine electronics device 400 or the peripheral devices 170. The available content may be provided as a free download or for purchase at a displayed price. Further, the marine electronics device 400 may send the request to the cloud server 150. In response to the request, the cloud server 150 may send a message back to the marine electronics device 400 that includes what content is currently being offered by the mobile content store 190 for the particular device. For instance, in the case of a particular sonar system, the received message from the cloud server 150 may include a list of software applications for the particular sonar system. As such, the list of software applications for the particular sonar system may be displayed on the marine electronics device 400.

Furthermore, the offered content may include one or more software applications for administering or managing the marine electronics device 400, the marine vessel 120, or the peripheral devices 170. As such, the software applications may use telematics data to manage a corresponding device. Telematics data may include measurements from sensors in the engine that record various operating conditions. Telematics data may also include information obtained from any device or system which is capable of being measured or controlled through electronic means, such as analog or digital methods. Such devices or systems may include switch position and switch activation systems, electric power generation and supply systems (e.g., AC and DC systems), water management systems for supply and/or consumption, lighting systems, and security systems. The telematics data may also describe how these and other systems such as the sonar system, radar system, propulsion systems (e.g., data regarding the engine's performance on the marine vessel 120, how long has the engine been operating, etc.) and other systems operate on the marine vessel 120.

Telematics data may also include data associated with a National Marine Electronics Association (NMEA) communication standard (e.g., NMEA 2000 or NMEA 0183). The NMEA communication standard may provide a protocol for communicating data acquired by sensors and marine instruments. The NMEA communication standard may also determine how display units or other devices on the marine vessel 120 receive and use the acquired data. For instance, NMEA compliant devices may include auto pilots, wind instruments, water temperature gauges, depth sounders, and engine instruments.

At block 240, a user using the marine electronics device 400 may purchase content (i.e., “the purchased content”) for the marine electronics device 400 or the peripheral devices 170 from the mobile content store 190. The purchased content may be similar to the offered content described at block 230. Block 240 is described in more detail in FIG. 3.

FIG. 3 illustrates a flow diagram for a method 300 of purchasing content from the mobile content store 190 in accordance with implementations of various techniques described herein. In one implementation, method 300 may be performed by the marine electronics device 400. It should be understood that while method 300 indicates a particular order of execution of operations, in some implementations, certain portions of the operations might be executed in a different order. Further, in some implementations, additional operations or steps may be added to the method 300. Likewise, some operations or steps may be omitted.

At block 310, the marine electronics device 400 may access the mobile content store 190 with a user account. For instance, a user may create a user account on the cloud server 150 using the marine electronics device 400. The user may also access an existing account.

As such, a user account may be associated with information relating to a respective user. For instance, the user account may include security information (e.g., an account identification, an account password, etc.), a personal profile (e.g., customer identification, such as name, address, phone number, etc.), product information registered to the user account (e.g., product serial numbers, the type of marine electronics device 400, the type of the marine vessel 120, and other component information, such as for a radar system or sonar system, etc.), and financial information (e.g., customer billing information, credit card information, purchase history, etc.). Information in the user account may be stored on the cloud server 150.

The respective user may access and modify information stored in the user account to verify accuracy. Security measures may be used to maintain the respective user's privacy and protect the respective user's sensitive personally identifiable information.

At block 320, the marine electronics device 400 may initiate a purchase transaction with the mobile content store 190. For instance, after logging into the mobile content store 190 with a user account at block 310, a person may use the web browser on the marine electronics device 400 to select an available item (e.g., a software application or other content) offered by the mobile content store 190. As such, the person may add the available item to a shopping cart or go directly to a web page to purchase the available item. With respect to the purchase transaction, a user may use the marine electronics device 400 to select one or more available items for a purchase order, input or approve corresponding financial information to pay for the available items in the purchase order, and/or review the purchase transaction before it is submitted to the cloud server 150.

At block 330, the marine electronics device 400 may send a request to complete the purchase transaction from block 320 to the cloud server 150. The request may be a message that describes the content to be purchased (i.e., “the purchased content”). The request may also include financial information associated with a user or user account to pay for the purchase transaction. For instance, the request may include a message that authorizes the cloud server 150 to obtain payment using financial information directed to a specified monetary account (e.g., a credit card account, a deposit account, a PayPal account, etc.) for the price of the purchase transaction (e.g., the price of the purchased content, taxes, extra fees, etc.). In another implementation, a near-field communication (NFC) or mobile payment may be used at the marine electronics device 400 to complete the purchase transaction.

At block 340, the mobile content store 190 may determine whether to authorize the purchase transaction. For instance, if financial information associated with the request from block 330 does not match a valid monetary account (e.g., the monetary account does not exist) or the monetary account has insufficient funds, the mobile content store 190 may refuse to complete the purchase transaction. If the financial information corresponds to a valid monetary account with sufficient funds to meet the price of the purchase transaction, the mobile content store 190 may approve the purchase transaction and provide the marine electronics device 400 with the capability to download the purchased content.

Returning to FIG. 2, at block 250, the marine electronics device 400 may download the purchased content or other offered content from the cloud server 150 or a location designated by the cloud server 150. For instance, upon completing a purchase transaction, the cloud server 150 may send the marine electronics device 400 a URL or website address for a location where the purchased content may be downloaded. Purchased content or other downloaded content from the mobile content store 190 may also be synchronized with a plurality of marine electronics devices or other electronic devices (e.g., purchased content for a particular user account may be synchronized between an iPad and the marine electronics device 400 registered to that user account).

At block 260, the marine electronics device 400 may use or install the purchased content or other offered content downloaded at block 250. Where the purchased content includes navigation charts, maps or similar content, the purchased content may be displayed on the marine electronics device 400. Software applications for the peripheral devices 170 may be operated on the marine electronics device 400 or installed directly to the peripheral devices 170.

### Marine Electronics Device

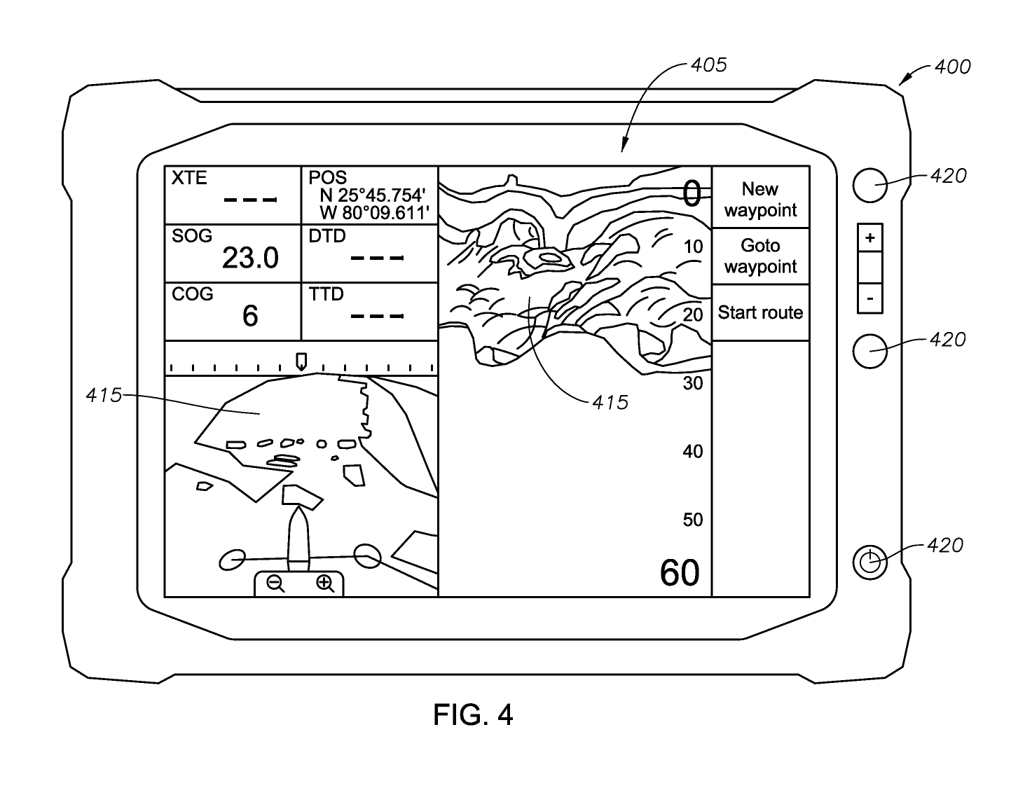

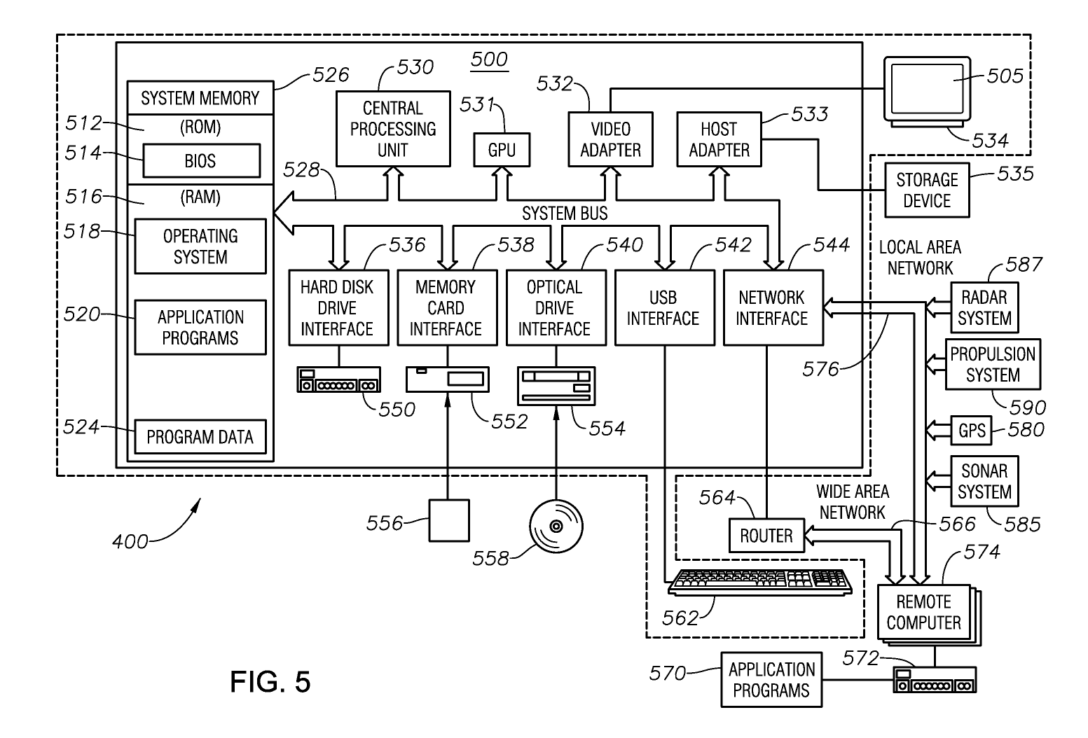

FIG. 4 illustrates a schematic diagram of a marine electronics device 400 in accordance with various implementations described herein. The components of the marine display device 400 are described in more detail with reference to the computing system 500 in FIG. 5. The marine electronics device 400 includes a screen 405. In certain implementations, the screen 405 may be sensitive to touching by a finger. In other implementations, the screen 405 may be sensitive to the body heat from the finger, a stylus, or responsive to a mouse. The display device 400 may display marine electronic data 415, e.g., purchased content. The marine electronic data types 415 may include chart data, radar data, sonar data, steering data, dashboard data, navigation data, fishing statistics, vessel systems data, and the like. The marine electronics device 400 may also include a plurality of buttons 420, which may be either physical buttons or virtual buttons, or a combination thereof.

### Computing System

Implementations of various technologies described herein may be operational with numerous general purpose or special purpose computing system environments or configurations. Examples of well-known computing systems, environments, and/or configurations that may be suitable for use with the various technologies described herein include, but are not limited to, personal computers, server computers, hand-held or laptop devices, multiprocessor systems, microprocessor-based systems, set top boxes, programmable consumer electronics, network PCs, minicomputers, mainframe computers, smart phones, tablets, wearable computers, cloud computing systems, virtual computer, and the like.

Various technologies described herein may be implemented in the context of marine electronics, such as devices found in marine vessels and/or navigation systems. Ship instruments and equipment may be connected to the computing systems described herein for executing one or more navigation technologies. As such, the computing systems may be configured to operate using sonar, radar, the global positioning system (GPS), propulsion systems, and like technologies.

Various technologies described herein may also be implemented in distributed computing environments where tasks are performed by remote processing devices that are linked through a communications network, e.g., by hardwired links, wireless links, or combinations thereof. In a distributed computing environment, program modules may be located in both local and remote computer storage media including memory storage devices.

Various technologies described herein may be implemented in computer-executable instructions, such as program modules, being executed by a computer. Generally, program modules include routines, programs, objects, components, data structures, etc. that performs particular tasks or implement particular abstract data types. Further, each program module may be implemented in its own way, and all need not be implemented the same way. While program modules may all execute on a single computing system, it should be appreciated that, in some implementations, program modules may be implemented on separate computing systems or devices adapted to communicate with one another. A program module may also be some combination of hardware and software where particular tasks performed by the program module may be done either through hardware, software, or both.

FIG. 5 illustrates a schematic diagram of the waypoint generation system 100 having a computing system 500 in accordance with implementations of various techniques described herein. The computing system 500 may be the marine electronics device 400, conventional desktop, a handheld device, a controller, a personal digital assistant, a server computer, an electronics device/instrument, a laptop, a tablet, or part of a navigation system, or sonar system. It should be noted, however, that other computer system configurations may be used.

The computing system 500 may include a central processing unit (CPU) 530, a system memory 526, a graphics processing unit (GPU) 531 and a system bus 528 that couples various system components including the system memory 526 to the CPU 530. Although only one CPU 530 is illustrated in FIG. 5, it should be understood that in some implementations the computing system 500 may include more than one CPU 530.

The CPU 530 can include a microprocessor, a microcontroller, a processor, a programmable integrated circuit, or a combination thereof. The CPU 530 can comprise an off-the-shelf processor such as a Reduced Instruction Set Computer (RISC), including an Advanced RISC Machine (ARM) processor, or a Microprocessor without Interlocked Pipeline Stages (MIPS) processor, or a combination thereof. The CPU 530 may also include a proprietary processor. The CPU 530 may include a multi-core processor.

The GPU 531 may be a microprocessor specifically designed to manipulate and implement computer graphics. The CPU 530 may offload work to the GPU 531. The GPU 531 may have its own graphics memory, and/or may have access to a portion of the system memory 526. As with the CPU 530, the GPU 531 may include one or more processing units, and each processing unit may include one or more cores.

The CPU 530 may provide output data to a GPU 531. The GPU 531 may generate graphical user interfaces that present the output data. The GPU 531 may also provide objects, such as menus, in the graphical user interface. A user may provide inputs by interacting with the objects. The GPU 531 may receive the inputs from interaction with the objects and provide the inputs to the CPU 530. A video adapter 532 may be provided to convert graphical data into signals for a monitor 534. The monitor 534 includes a screen 505. The screen 505 can be sensitive to heat or touching (now collectively referred to as a “touch screen”). In one implementation, the host computer 599 may not include a monitor 534. In one implementation, the CPU 530 may perform the tasks of the GPU.

The system bus 528 may be any of several types of bus structures, including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral device Interconnect (PCI) bus also known as Mezzanine bus. The system memory 526 may include a read only memory (ROM) 512 and a random access memory (RAM) 516. A basic input/output system (BIOS) 514, containing the basic routines that help transfer information between elements within the computing system 500, such as during start-up, may be stored in the ROM 512.

Certain implementations may be configured to be connected to a global positioning system (GPS) 580, a sonar system 585, a radar system 587, and propulsion system 590. The GPS 580, the sonar system 585, the radar system 587, and/or the propulsion system 590 may be connected via the network interface 544. The computing system 500, the monitor 534, the screen 505, and buttons may be integrated into a console.

The computing system 500 may further include a hard disk drive interface 536 for reading from and writing to a hard disk 550, a memory card reader 552 for reading from and writing to a removable memory card 556, and an optical disk drive 554 for reading from and writing to a removable optical disk 558, such as a CD ROM or other optical media. The hard disk 550, the memory card reader 552, and the optical disk drive 554 may be connected to the system bus 528 by a hard disk drive interface 536, a memory card reader interface 538, and an optical drive interface 540, respectively. The drives and their associated computer-readable media may provide nonvolatile storage of computer-readable instructions, data structures, program modules and other data for the computing system 500.

Although the computing system 500 is described herein as having a hard disk, a removable memory card 556 and a removable optical disk 558, it should be appreciated by those skilled in the art that the computing system 500 may also include other types of computer-readable media that may be accessed by a computer. For example, such computer-readable media may include computer storage media and communication media. Computer storage media may include volatile and non-volatile, and removable and non-removable media implemented in any method or technology for storage of information, such as computer-readable instructions, data structures, program modules or other data. Computer storage media may further include RAM, ROM, erasable programmable read-only memory (EPROM), electrically erasable programmable read-only memory (EEPROM), flash memory or other solid state memory technology, including a Solid State Disk (SSD), CD-ROM, digital versatile disks (DVD), or other optical storage, magnetic cassettes, magnetic tape, magnetic disk storage or other magnetic storage devices, or any other medium which can be used to store the desired information and which can be accessed by the computing system 500. Communication media may embody computer readable instructions, data structures, program modules or other data in a modulated data signal, such as a carrier wave or other transport mechanism and may include any information delivery media. The term “modulated data signal” may mean a signal that has one or more of its characteristics set or changed in such a manner as to encode information in the signal. By way of example, and not limitation, communication media may include wired media such as a wired network or direct-wired connection, and wireless media such as acoustic, RF, infrared and other wireless media. The computing system 500 may also include a host adapter 533 that connects to a storage device 535 via a small computer system interface (SCSI) bus, a Fiber Channel bus, an eSATA bus, or using any other applicable computer bus interface. The computing system 500 can also be connected to a router 564 to establish a wide area network (WAN) 566 with one or more remote computers 574 (e.g., the cloud server 150). The router 564 may be connected to the system bus 528 via a network interface 544. The remote computers 574 can also include hard disks 572 that store application programs 570 (e.g., the mobile content store 190).

In another implementation, as discussed in more detail with respect to FIG. 2, the computing system 500 may also connect to one or more remote computers 574 via local area network (LAN) 576 or the WAN 566. When using a LAN networking environment, the computing system 500 may be connected to the LAN 576 through the network interface or adapter 544. The LAN 576 may be implemented via a wired connection or a wireless connection. The LAN 576 may be implemented using Wi-Fi technology, cellular technology, or any other implementation known to those skilled in the art. The network interface 544 may also utilize remote access technologies (e.g., Remote Access Service (RAS), Virtual Private Networking (VPN), Secure Socket Layer (SSL), Layer 2 Tunneling (L2T), or any other suitable protocol). These remote access technologies may be implemented in connection with the remote computers 574. It will be appreciated that the network connections shown are exemplary and other means of establishing a communications link between the computer systems may be used. The network interface 544 may also include digital cellular networks (e.g., GSM), Bluetooth, or any other wireless network interface.

A number of program modules may be stored on the hard disk 550, memory card 556, optical disk 558, ROM 512 or RAM 516, including an operating system 518, one or more application programs 520, and program data 524. In certain implementations, the hard disk 550 may store a database system. The database system could include, for example, recorded points. The application programs 520 may include various mobile applications (“apps”) and other applications configured to perform various methods and techniques described herein. The operating system 518 may be any suitable operating system that may control the operation of a networked personal or server computer.

A user may enter commands and information into the computing system 500 through input devices such as a keyboard 562 and pointing device. Other input devices may include a microphone, joystick, game pad, satellite dish, scanner, user input button, or the like. These and other input devices may be connected to the CPU 530 through a Universal Serial Bus (USB) interface 542 coupled to system bus 523, but may be connected by other interfaces, such as a parallel port, Bluetooth, or a game port. A monitor 505 or other type of display device may also be connected to system bus 528 via an interface, such as a video adapter 532 or a wireless interface. In addition to the monitor 534, the computing system 500 may further include other peripheral output devices such as speakers and printers.

While the foregoing is directed to implementations of various techniques described herein, other and further implementations may be devised without departing from the basic scope thereof, which may be determined by the claims that follow. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A marine electronics device, comprising:
one or more processors; and
memory having a plurality of executable instructions which, when executed by the one or more processors, cause the one or more processors to:
send a request from the marine electronics device to a cloud server, wherein the request is configured to purchase content for the marine electronics device or one or more peripheral devices in communication with the marine electronics device; and
receive the purchased content at the marine electronics device.

2. The marine electronics device of claim 1, wherein the memory further comprises executable instructions that cause the one or more processors to:
connect to the cloud server over a network connection; and
authenticate the network connection using information stored in a user account.

3. The marine electronics device of claim 1, wherein the memory further comprises executable instructions that cause the one or more processors to control the operation of a marine vessel.

4. The marine electronics device of claim 1, wherein the memory further comprises executable instructions that cause the one or more processors to receive a selection on a web browser to purchase the content, and wherein the request is sent in response to receiving the selection.

5. The marine electronics device of claim 1, wherein the request is configured to authorize payment for the purchased content using financial information stored in a user account.

6. The marine electronics device of claim 1, wherein the purchased content comprises:
one or more navigation charts;
musical content;
entertainment media;
one or more games;
weather information;
fishing information; or
a combination thereof.

7. The marine electronics device of claim 1, further comprising a screen and wherein the memory further comprises computer-executable instructions which cause the one or more processors to display the purchased content on the screen.

8. The marine electronics device of claim 1, wherein the purchased content is a software application configured to manage the one or more peripheral devices.

9. The marine electronics device of claim 1, wherein the one or more peripheral devices comprise:
a radar system;
a sonar system;
a propulsion system;
a global positioning system (GPS) device; or
a combination thereof.

10. The marine electronics device of claim 1, wherein the executable instructions that cause the one or more processors to receive the purchased content comprise executable instructions that cause the one or more processors to receive, from the cloud server, a designated location for downloading the purchased content.

11. A non-transitory computer-readable medium having stored thereon a plurality of computer-executable instructions which, when executed by a computer, cause the computer to:
receive a request from a marine electronics device to purchase content, wherein the request corresponds to financial information associated with a user;
determine whether to authorize a purchase transaction for the purchased content based on the financial information; and
if the purchase transaction is authorized, provide a download location for the purchased content to the marine electronics device.

12. The non-transitory computer-readable medium of claim 11, wherein the financial information is credit card information.

13. The non-transitory computer-readable medium of claim 11, wherein the purchased content is configured for being displayed on the marine electronics device.

14. The non-transitory computer-readable medium of claim 11, wherein the purchased content is a software application configured to manage one or more devices disposed on a marine vessel.

15. The non-transitory computer-readable medium of claim 11, wherein the computer-executable instructions which, when executed by the computer, cause the computer to determine whether to authorize the purchase comprise computer-executable instructions which cause the computer to authorize the purchase transaction if the financial information corresponds to a monetary account with funds sufficient to meet the price of the purchase transaction.

16. The non-transitory computer-readable medium of claim 15, wherein the monetary account is a credit card account or a deposit account.

17. The non-transitory computer-readable medium of claim 11, wherein the computer-executable instructions which, when executed by the computer, cause the computer to determine whether to authorize the purchase comprise computer-executable instructions which cause the computer to deny the purchase transaction if the financial information does not match an existing monetary account.

18. The non-transitory computer-readable medium of claim 14, wherein the devices disposed on the marine vessel comprise:
a radar system;
a sonar system;
a propulsion system on the marine vessel;
a global positioning system (GPS) device; or
a combination thereof.

19. The non-transitory computer-readable medium of claim 1, wherein the download location is on a cloud server.

20. A non-transitory computer-readable medium having stored thereon a plurality of computer-executable instructions which, when executed by a computer, cause the computer to:
receive a request, at a marine electronics device, to display content that is available for download from a mobile content store in communication with the marine electronics device; and
display the content on the marine electronics device in response to the request.
